(19) United States
(12) Patent Application Publication
(10) Pub. No.: US 2023/0000025 A1
(43) Pub. Date: Jan. 5, 2023

(54) PLANT SUPPORT SYSTEMS AND METHODS OF OPERATING THE SAME

(71) Applicant: Zauben LLC, Chicago, IL (US)

(72) Inventors: Zachary SMITH, Chicago, IL (US); Joshua Lev BERGER, Chicago, IL (US); Lewis EPSTEIN, Jackson Heights, NY (US)

(73) Assignee: Zauben LLC, Chicago, IL (US)

(21) Appl. No.: 17/852,447

(22) Filed: Jun. 29, 2022

Related U.S. Application Data
(60) Provisional application No. 63/217,541, filed on Jul. 1, 2021.

(51) Int. Cl. A01G 9/029; A01G 9/20; A01G 31/06

(52) U.S. Cl. CPC A01G 9/0297; A01G 9/20; A01G 31/06

(57) ABSTRACT

Embodiments described herein relate to plant support systems and methods of operating the same. In some embodiments, a plant support system includes a housing that physically supports a plurality of living plants. The housing includes a plurality of panels arranged in a vertical array of n rows and m columns, n and m being positive integers. Each panel from the plurality of panels contains a living plant from the plurality of living plants. The plant support system further includes a plurality of pumps. Each pump from the plurality of pumps delivers water to one of the rows in the housing. In some embodiments, the plurality of pumps includes a first pump programmed to deliver a first volume of water to a first row of the plurality of panels at a first pressure head corresponding to a height of the first row of the plurality of panels.

### CROSS-REFERENCE TO RELATED APPLICATIONS

This application claims priority to U.S. Provisional Patent Application No. 63/217,541, entitled “Plant Support Systems and Methods of Operating the Same,” filed on Jul. 1, 2021, the disclosure of which is incorporated by reference herein in its entirety.

### TECHNICAL FIELD

Embodiments described herein relate to systems for supporting plant life and methods of operating the same.

### BACKGROUND

Plant walls (also referred to as living walls, or green walls) provide space-efficient gardening options to support living plant life. While plant walls can improve the appearance and air quality of an indoor and/or outdoor space, they can be difficult to maintain. Delivering water to each of the plants in a plant wall can be labor intensive, and automated water delivery systems can be unreliable, inefficient, and/or unbalanced (e.g., leading to overwatering of some plants and underwatering of others). A lack of water or excess water delivery to a plant in a plant wall can often go undetected until all or part of the plants starts to die. For example, some known plant walls operate by watering a top row of the plant wall and allowing excess water to trickle down to lower rows. Such plant walls will tend to overwater the top row and underwater the bottom row. Other known plant walls may water individual rows of plants that are partially isolated from each other, for example, by allowing excess water to flow into a permeable drain layer. Such plant walls may nonetheless allow excess water from higher rows to backflow into lower rows, which can result in overwatering of lower rows. This can create inefficiencies, as replacement of dead plants can be costly, both from an economic perspective and from a time perspective. Monitoring water delivery to individual plants or groups of plants can substantially prevent plant death and reduce maintenance costs of a plant wall.

Additionally, systems for watering plants in a plant wall can be prone to failure, for example watering lines and/or drip holes can become clogged. When watering systems of known systems fail, identifying the point of failure can be complex and/or repair may require replacement of functional portions of the watering system. Therefore, maintaining and repairing known plant walls can be time consuming and expensive. Accordingly, a need exists for systems and methods that enable the monitoring of water delivery to individual plants or groups of plants and systems and methods that allow for failures of watering systems to be rapidly identified for targeted repair or replacement.

### SUMMARY

Embodiments described herein relate to plant support systems and methods of operating the same. In some embodiments, a plant support system includes a housing that physically supports a plurality of living plants. The housing includes a plurality of panels arranged in a vertical array of n rows and m columns, n and m being positive integers. Each panel from the plurality of panels can contain at least one living plant. The plant support system further includes at least one pump. The pump(s) deliver water to each row of the housing. Some embodiments include a first pump programmed to deliver a first volume of water to a first row of the plurality of panels at a first pressure head corresponding to a height of the first row of the plurality of panels and a second pump programmed to deliver a second volume of water to a second row of the plurality of panels at a second pressure head corresponding to a height of the second row of the plurality of panels. In some embodiments, the first volume of water is the same as the second volume of water and the first pressure head is different from the second pressure head.

### BRIEF DESCRIPTION OF THE DRAWINGS

FIG. 1 is a block diagram of a plant support system, according to an embodiment.

FIGS. 2A-2B are illustrations of a plant support system, according to an embodiment.

FIGS. 3A-3D are illustrations of panels of a plant support system, according to an embodiment.

FIG. 4 is an illustration of a collection of pumps and tubes of a plant support system, according to an embodiment.

FIG. 5 is an illustration of a collection of panels, pumps, and tubes of a plant support system, according to an embodiment.

FIG. 6 is an illustration of a panel with a riser line and an emitter line that deliver water to the panel, according to an embodiment.

FIG. 7 is an illustration of a panel with an emitter line, including drip holes for delivery of water from the emitter line to the panel, according to an embodiment.

FIG. 8 is an illustration of an illumination system, according to an embodiment.

### DETAILED DESCRIPTION

Embodiments described herein generally relate to plant support systems and methods of operating the same. Monitoring and controlling the watering of individual plants or individual sections of plants can be a challenging process. Some embodiments of plant walls can be architecturally integrated into a building. Such plant walls may be custom built and plumbed to the building's high-pressure water lines and/or waste water lines. Such high-pressure custom-built systems can have costly installations, as they often rely on a room in a building near the plant wall to house an irrigation control system. The irrigation control system can receive incoming water, reduce the pressure, and inject a small amount of fertilizer. Any water not used by the plants is often drained and not used again. Other embodiments of plant walls can be “stand alone” units. Such units may include a recirculating design that need less frequent addition of fresh water and/or less frequent disposal of used water. Such walls may also be easier to install and may not require tapping into building plumbing, as the water supply can be filled at various rates (e.g., every 2-3 weeks) with a watering can and/or a hose, depending on tank size and consumption rate. However, according to known designs, emitter clogging can become very difficult to manage in a recirculating tank wall design because, by recirculating the same water repeatedly, precipitates and/or sediments can build up in the emitters and cause clogs.

Additionally, plant walls can include moisture sensors and/or other types of localized sensors that can detect problems if the sensor happens to be placed in a problematic area. However, the initial cost and maintenance (e.g., battery changes, recalibration, etc.) of such sensors can be prohibitive. Some known plant walls implement a few (e.g., one or two) sensors, in areas where it is suspected that less water will be delivered. Such an approach may be insufficient to detect unexpected and slower to develop blockages. Plant support systems described herein include precise, cost-efficient water management techniques to reduce the amount of maintenance needed in the plant support system.

Metering and/or monitoring water delivery to individual plants or rows of plants can aid in preventing plant death and improve the efficiency of the plant support system. In some embodiments, the plant support system can be divided into an array of panels. The panels can be organized vertically in rows and horizontally in columns. In other words, the rows of panels can be vertically stacked upon one another. A water delivery system can deliver water to each of the panels of the plant support system. Delivery of water into each panel and/or each column can be monitored, such that a clog or other impedance in the water delivery system can be quickly pinpointed.

Plant support systems that monitor the delivery of water to each panel and/or column can be advantageous over plant support systems without such a monitoring ability, as a failure to deliver water (e.g., due to a clog or mechanical failure) can be identified long before the plants dry out and start to die. This contrasts to known plant support systems in which users typically rely on visual cues to determine whether a section of a plant support system is not receiving the right amount of water. By the time the plants show visual signs of dehydration, they have already begun to die, and are often beyond the point of revitalization. Replacement of dead plants may be necessary to maintain the visual appeal of the plant support system. This can be costly and labor intensive, particularly in large plant support systems. For example, if a plant support system is disposed on the side of a tall building and covers an entire side of the building, replacement of one or more plants in the plant support system may require ladders or scaffolding. By monitoring the water delivery to such a plant support system with specificity, the average plant life can be extended, such that maintenance costs are reduced and the visual appeal of the plant support system is maintained more consistently.

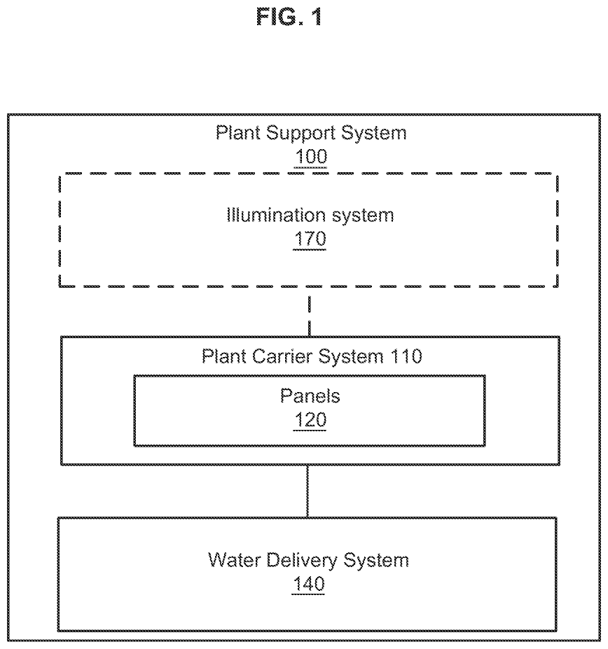

FIG. 1 is a block diagram of a plant support system 100, according to an embodiment. As shown, the plant support system 100 includes a plant carrier system 110 with panels 120 and a water delivery system 140. The plant support system 100 optionally includes an illumination system 170. The plant carrier system 110 provides structural organization and physical support for plant life grown in the plant support system 100, while the water delivery system 140 includes equipment for delivery of water to the plant life in the plant carrier system 110.

The plant carrier system 110 can include one or more housing structures. The panels 120 can be disposed in the plant carrier system 110. In some embodiments, the panels 120 can be held in the housing structure(s) via brackets. In some embodiments, each of the panels 120 can physically support one plant. In some embodiments, each of the panels 120 can physically support multiple plants. The panels 120 can be arranged in an array of rows and columns. Each of the rows of the panels 120 can be stacked vertically upon one another. The panels 120 can be modular and configured to be reversibly coupled to the plant carrier system 110. Similarly stated, the panels can be configured such that they can be inserted, removed, and/or moved between various locations (e.g., different rows and/or columns) of the plant carrier system 110.

In various instances, the plant carrier system 110 can include at least 2, at least 3, at least 4, at least 5, at least 6, at least 7, at least 8, at least 9, at least 10, at least 20, at least 30, at least 40, at least 50, at least 60, at least 70, at least 80, at least 90, at least 100, at least 200, at least 300, at least 400, at least 500, at least 600, at least 700, at least 800, or at least 900 rows of the panels 120.

In various instances, the plant carrier system 110 can include no more than 1,000, no more than 900, no more than 800, no more than 700, no more than 600, no more than 500, no more than 400, no more than 300, no more than 200, no more than 100, no more than 90, no more than 80, no more than 70, no more than 60, no more than 50, no more than 40, no more than 30, no more than 20, no more than 10, no more than 9, no more than 8, no more than 7, no more than 6, no more than 5, no more than 4, or no more than 3 rows of the panels 120. Combinations of the above-referenced numbers of rows of the panels 120 are also possible (e.g., at least 2 and no more than 1,000 rows of the panels 120 or at least 20 and no more than 40 rows of the panels 120), inclusive of all values and ranges therebetween. In various instances, the plant carrier system 110 can include 2, 3, 4, 5, 6, 7, 8, 9, 10, 20, 30, 40, 50, 60, 70, 80, 90, 100, 200, 300, 400, 500, 600, 700, 800, 900, or 1,000 rows of the panels 120.

In various instances, the plant carrier system 110 can include at least 2, at least 3, at least 4, at least 5, at least 6, at least 7, at least 8, at least 9, at least 10, at least 20, at least 30, at least 40, at least 50, at least 60, at least 70, at least 80, at least 90, at least 100, at least 200, at least 300, at least 400, at least 500, at least 600, at least 700, at least 800, or at least 900 columns of the panels 120. In various instances, the plant carrier system 110 can include no more than 1,000, no more than 900, no more than 800, no more than 700, no more than 600, no more than 500, no more than 400, no more than 300, no more than 200, no more than 100, no more than 90, no more than 80, no more than 70, no more than 60, no more than 50, no more than 40, no more than 30, no more than 20, no more than 10, no more than 9, no more than 8, no more than 7, no more than 6, no more than 5, no more than 4, or no more than 3 columns of the panels 120. Combinations of the above-referenced numbers of columns of the panels 120 are also possible (e.g., at least 2 and no more than 1,000 columns of the panels 120 or at least 20 and no more than 40 columns of the panels 120), inclusive of all values and ranges therebetween. In various instances, the plant carrier system 110 can include 2, 3, 4, 5, 6, 7, 8, 9, 10, 20, 30, 40, 50, 60, 70, 80, 90, 100, 200, 300, 400, 500, 600, 700, 800, 900, or 1,000 columns of the panels 120.

The panels 120 can have any form factor. For example, the panels 120 can have a rectangular cross section, a square cross section, an elliptical cross section, a circular cross section, a triangular cross section, or any other form factor, or combinations thereof. In some instances, each of the panels 120 can have edges that, when disposed in the plant carrier system 110, are flush or substantially flush with one another. In other words, the spacing between adjacent panels 120 can be minimized. In some instances, the panels 120 can be spaced apart from one another (e.g., spaced apart by about 1 cm, about 2 cm, about 3 cm, about 4 cm, about 5 cm, about 6 cm, about 7 cm, about 8 cm, about 9 cm, or about 10 cm, inclusive of all values and ranges therebetween).

Each panel 120 can contain (or be configured to contain) one or more plants. For example, each panel can include rock wool, or any other suitable substrate to promote plant growth. Typically, each panel 120 is configured for plants to grow hydroponically or aeroponically. Similarly stated, typically, panels 120 do not include soil. It should be understood, however, that in some embodiments, panels 120 may include soil.

The plant carrier system 110 can include one or more sensors to detect delivery of water to the panels 120. In some embodiments, the sensors can be incorporated into the housing that holds the panels 120. In some embodiments, the sensors can be incorporated into the panels 120 to detect delivery of water to the panels 120. In some embodiments, the panels 120 can include moisture sensors disposed therein to monitor the moisture levels of each of the panels 120. In some embodiments, the moisture sensors can be Wi-Fi-enabled. In some embodiments, the moisture sensors can be connected to Wi-Fi. In some embodiments, the panels 120 can include one or more devices to measure delivery of water to the panels 120 in real time. In some embodiments, the housing and/or the panels 120 can include a strain gauge to measure water delivery. In some embodiments, a single strain gauge can measure water delivery to a column of the panels 120 and/or water exiting from the column of the panels 120. In some embodiments, one or several or all of the panels 120 can include a strain gauge that registers a strain change each time an amount of water is delivered to one of the panels 120. For example, when water is delivered to one of the panels 120, it can saturate the matrix and excess water can exit via a drain opening, for example in a stream and/or a series of droplets. The strain gauge can detect a deflection and/or change in strain as water exiting the panel strikes or otherwise affects the sensor. As water is added to a panel 120, the flow exiting the panel will typically increase until the matrix is fully saturated, reach a steady state, and then once the watering has ceased, decrease. Therefore, by detecting the rate at which water exits the panel 120 (or column of panels) and/or the pattern of droplet strikes, the sensor can be operable to monitor the watering state of a panel and/or detect malfunctions (e.g., clogs). For example, if a pump is operating and attempting to deliver water to a panel, but no water is detected exiting the panel (e.g., within a predetermined period of time), this can be an indication that the panel 120 is not receiving water. In addition or alternatively, by detecting when and/or at what rate water exits the panel 120 (or column of panels), the sensor can be operable to monitor when a panel is fully saturated. When the monitoring system determines that a panel is fully saturated, one or more of the pumps can be shut off (e.g., manually or automatically). Such control of deployment of water can improve water efficiency as well as energy efficiency. The strain gauges can communicate with a monitoring system. The monitoring system can include a user interface operable to present information about the delivery of water to each of the panels 120. Based on the data appearing on the user interface, a user can determine which panels (if any) are not receiving adequate water and can accordingly pinpoint a location of a clog or other impedance to water delivery. For example, the monitoring system can include an alert protocol. For example, an alarm can sound, indicating that adequate water is not being delivered to one or more of the panels 120.

In some embodiments, excess water dripped from the panels 120 can be detected via an electrical conductivity (EC) sensor (not shown). For example, the excess water can be collected in a reservoir (e.g., a vee-shaped reservoir that is tilted so water can drain out as it is collected). As the water drains, the water can complete a circuit for two or more probes placed in the reservoir. The EC sensor can detect a change in resistance between the probes. In addition to water sensing, an EC sensor can sense nutrient concentrations and alert the user when there is an excess or deficiency of nutrient solution, for example, based on conductivity of water as it drains past two or more probes.

The water delivery system 140 can include a series of pumps, tubes, and orifices for delivery of water to the plant carrier system 110. In some embodiments, the water delivery system 140 can include multiple pumps, each pump delivering water to a specified row of panels 120. In other words, each pump can be configured to have an outlet pressure corresponding to a height of a row of panels. Each pump can be fluidically coupled to a series of tubes to deliver water to a specified row of the panels 120.

By having a 1:1 pump to row ratio, water delivery problems can be more accurately pinpointed, and the percentage of the panels 120 that are out of use during repairs can be minimized. For example, if each of the panels 120 on the third row of panels are not receiving adequate water, there may be an issue with the pump that delivers water to the third row of panels. There may also be a clog on a riser line that delivers water to the third row of panels. In either case, only the third row of panels is out of order during repair. In contrast, in a system with a single pump delivering all of the water to the system, delivery of water to the entire system can be halted while the problem is pinpointed, particularly if the pump needs repair or replacement. In some embodiments, the pumps included in the water delivery system 140 can be fluidically coupled to a reservoir (not shown). In some embodiments, excess water can exit the panels 120 and re-enter the reservoir via a series of drainage channels and gutters.

In some embodiments, the water delivery system 140 can include a single pump that selectively delivers water to the rows of panels 120 via one or more valves. For example, a valve can be fluidically coupled to the pump and can allow fluidic communication between the pump and a first row of the panels 120 in a first configuration. The valve can allow fluidic communication between the pump and a second row of the panels in a second configuration. In some embodiments, the valve can allow fluidic communication between the pump and a third row of panels in a third configuration.

The illumination system 170 is an optional component of the plant support system 100. The illumination system 170 can provide light to the plants in the plant support system 100. In some instances, the plant support system 100 can be placed outdoors, such that sunlight provides illumination. In other instances, the plant support system 100 can be placed indoors. In some instances, the illumination system 170 can supplement the sunlight provided or can operate during nights or overcast days. In some embodiments, the illumination system 170 can include incandescent light bulbs. In some embodiments, the illumination system 170 can include light emitting diodes (LED's). In some embodiments, the illumination system 170 can include an array of light sources. In some embodiments, the illumination system 170 can include a single row of light sources. In some embodiments, the illumination system 170 can include multiple rows of light sources. In some embodiments, the illumination system 170 can include a row of light sources for each row of the panels 120. In some instances, the plant support system 100 can be mounted onto a wall. In some instances, the plant support system 100 can be freestanding.

In some embodiments, the illumination system 170 can be mounted to a wall. In some embodiments, the illumination system 170 can be mounted to a wall opposite the plant carrier system 110. In some embodiments, the illumination system 170 can include one or more light sources coupled to an arm. In some embodiments, the arm can be mounted to the wall via a hinge. In some embodiments, the hinge can include a spring-detent, such that the arm can be lifted up to a desired level where the spring-detent holds the arm in place. In some embodiments, the arm can be pre-assembled, such that it can be shipped in a folded state, unfolded upon arrival, and mounted to the wall with the hinge. In other embodiments, the illumination system 170 can be free standing (e.g., self supporting without being directly coupled to a wall or the plant carrier system 110).

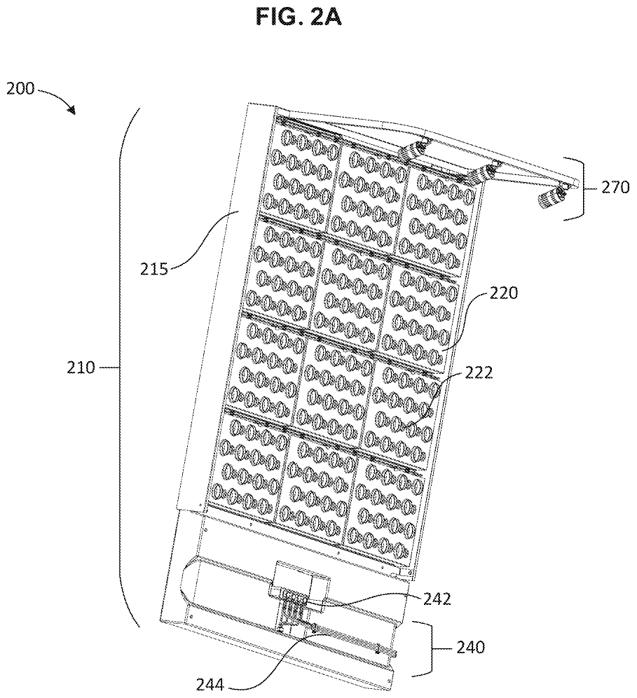

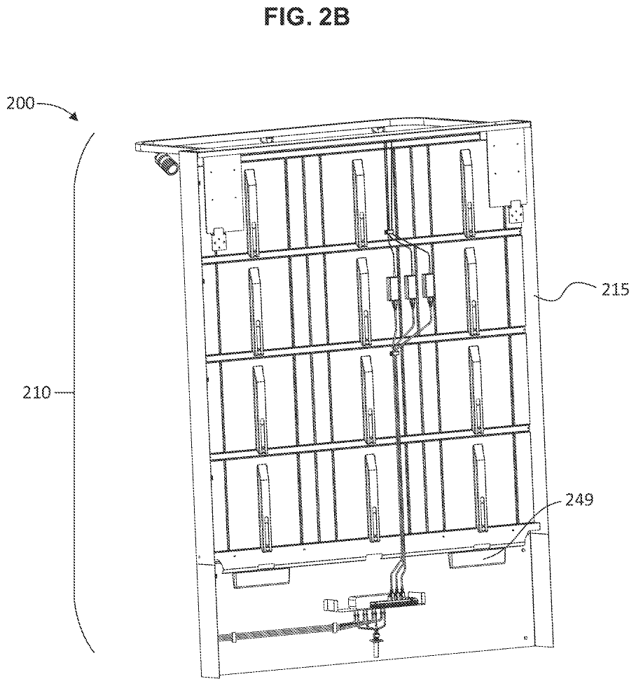

FIGS. 2A-8 show a plant support system 200, according to an embodiment. As shown, the plant support system 200 includes a plant carrier system 210, a water delivery system 240, and an illumination system 270. As shown, the plant carrier system 210 includes a housing 215, panels 220, seeding holes 222, air gap strips 223, seeding cavities 224, outflows 225, drain openings 226, and upper surfaces 227. As shown, the water delivery system 240 includes a plurality of pumps 242, riser lines 244, emitter lines 246, drip holes 248, filters 249, and feeder lines 250. As shown, the illumination system 270 includes a light source 272 and a support beam 274. The plant carrier system 210, the water delivery system 240, and the illumination system 270 can be the same or substantially similar to the plant carrier system 110, the water delivery system 140, and the illumination system 170, as described above with reference to FIG. 1. Thus, certain aspects of the plant carrier system 210, the water delivery system 240, and the illumination system 270 are not described in greater detail herein. FIG. 2A shows a frontside view of the plant support system 200, while FIG. 2B shows a rear view of the plant support system 200.

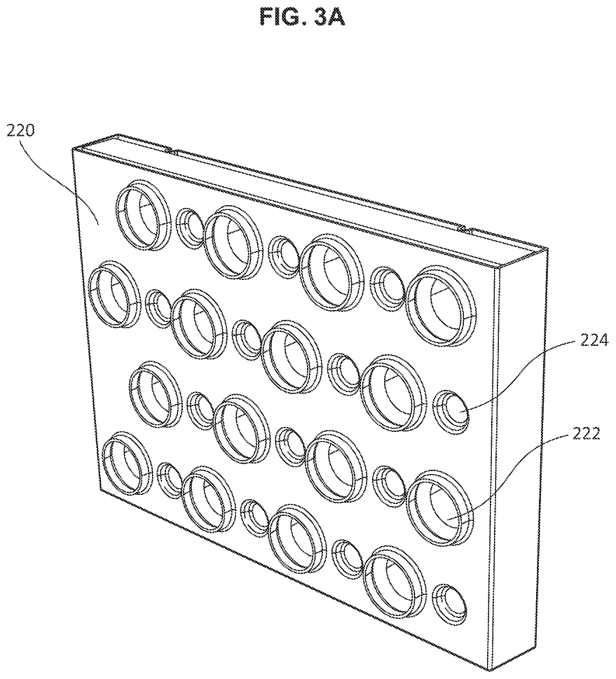

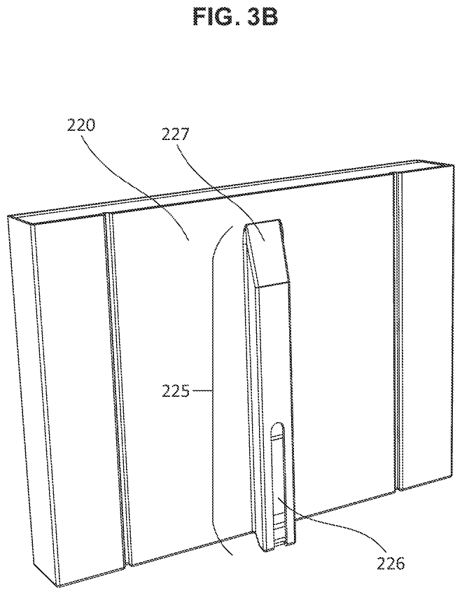

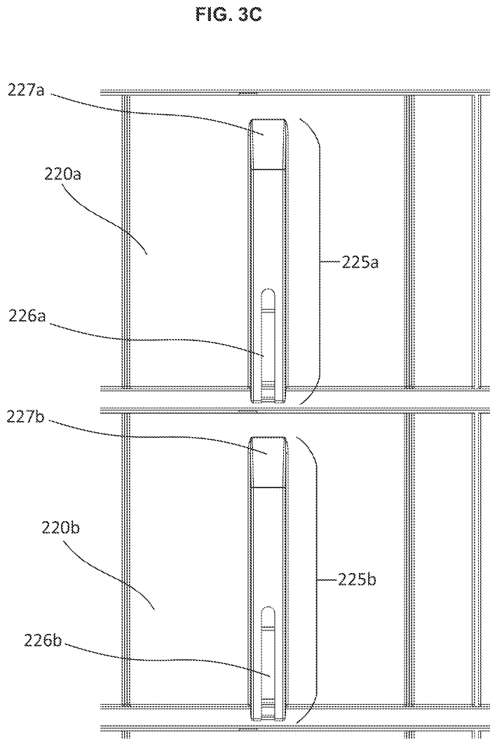

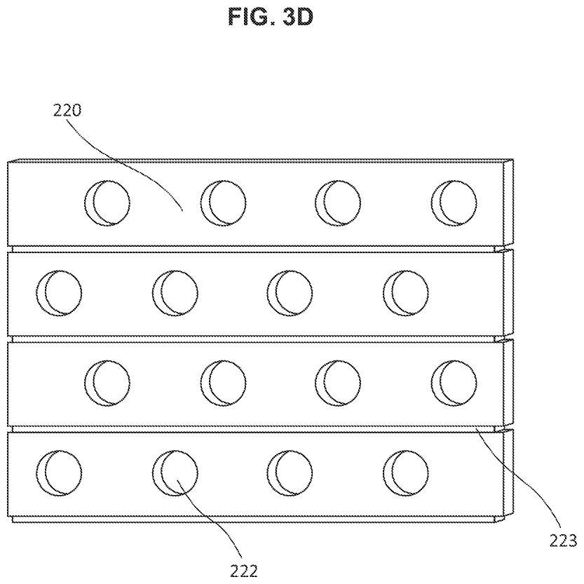

FIG. 3A shows a frontside view of one of the panels 220, FIG. 3B shows a rear view of one of the panels 220, FIG. 3C shows a rear view of two of the panels 220 stacked upon one another, and FIG. 3D shows view of a cross section of one of the panels 220, showing an interior of the panel 220. As shown, the plant carrier system 210 includes four rows of panels 220 and three columns of panels 220. In some embodiments, the plant carrier system 210 can include any number of rows and columns of the panels 220, as described above with reference to the plant carrier system 110 and FIG. 1. As shown in FIG. 3A, the panels 220 include seeding holes 222 and seeding cavities 224. In some embodiments, a growing medium such as seeds, bulbs, and/or plants can be planted in the seeding holes 222. In some instances, seeds, bulbs, and/or plants can be planted in the seeding cavities 224. The seeding holes 222 penetrate the full depth of the panels 220 while the seeding cavities only partially indent the panels 220. In some instances, the plants can be rooted in the seeding holes 222 while the seeding cavities 224 provide aeration for the plants. The seeding cavities 224 can provide aeration to space the growing medium away from the surface of the panels 220. This can ensure that there is air on substantially all sides around the growing medium, such that roots can grow out into the growing medium in substantially all directions. In other embodiments, the seeding holes 222 can be configured to accept larger plants, while the seeding cavities are configured to accept smaller plants. In some instances, each of the seeding holes 222 can support one plant. In some instances, one or more of the seeding holes 222 can support multiple plants. In some instances, one or more of the seeding holes 222 can be vacant of plant roots and can simply provide aeration. The seeding cavities 224 can penetrate to a depth of about 10%, about 20%, about 30%, about 40%, about 50%, about 60%, about 70%, about 80%, or about 90% of the total depth of the panels 220, inclusive of all values and ranges therebetween.

As shown in FIG. 3A, the seeding holes 222 and the seeding cavities 224 are arranged in an alternating pattern (i.e., looking from left to right, one seeding hole 222 is followed by one seeding cavity 224, and so on). In some embodiments, multiple seeding holes 222 can be arranged side by side, followed by multiple seeding cavities 224. As shown in FIG. 3A, the seeding holes 222 and the seeding cavities 224 are arranged in multiple rows on each of the panels 220. As shown, the rows are staggered. In other words, a seeding hole 222 is directly above a seeding cavity 224 and a seeding cavity 224 is directly above a seeding hole 222. In some embodiments, the rows can be in-line, such that the seeding holes 222 are vertically in-line with each other and the seeding cavities 224 are vertically in-line with each other. As shown in FIG. 3A, the panel 220 includes 4 rows of seeding holes 222 and seeding cavities 224. The panel 220 can include 1, 2, 3, 4, 5, 6, 7, 8, 9, 10, 15, 20, 25, 30, 35, 40, 45, 50, 55, 60, 65, 70, 75, 80, 85, 90, 95, or 100 rows, inclusive of all values and ranges therebetween, or any other suitable number of rows. Each row can include 1, 2, 3, 4, 5, 6, 7, 8, 9, 10 15, 20, 25, 30, 35, 40, 45, 50, 55, 60, 65, 70, 75, 80, 85, 90, 95, or 100 seeding holes 222 and/or seeding cavities 224, inclusive of all values and ranges therebetween, or any other suitable number of rows. Each of the panels 220 can be movable independent of one another so that strain or movement of one of the panels 220 does not cause strain or movement in the other panels 220. In some embodiments, each of the panels 220 can include a moisture sensor (not shown). In some embodiments, the plant carrier system 210 can include one or at least one moisture sensor per row of panels 220. Inclusion of one moisture sensor per row of panels 220 can enable moisture sensing at each vertical position along the plant carrier system 210. In some embodiments, at least a portion of the moisture sensors can be Wi-Fi enabled. In some embodiments, the plant carrier system 210 can include a mobile hotspot device (e.g., cellular data modem, a 4G router, a 5G router, etc.). The mobile hotspot device can provide the plant support system 200 with its own internet connection.

FIG. 3B shows a rear view of panel 220. FIG. 3C shows two panels of a column 220a and 220b. As shown, the panel 220 includes an outflow 225. The outflow 225 includes a drain opening 226 coming out the back of the panel 220 and an upper surface 227. The upper surface 227 can aid in deflecting water that has exited other panels positioned above the panel 220. FIG. 3C shows a first panel 220a and a second panel 220b. The first panel 220a includes a first outflow 225a with a first upper surface 227a and a first drain opening 226a. The second panel 220b includes a second outflow 225b with a second upper surface 227b and a second drain opening 226b. The second upper surface 227b can prevent or inhibit water exiting the first drain opening 226a from backflowing into the second drain opening 226b. As shown, the second upper surface 227b is angled to deflect water away from re-entering the second panel 220b via the second drain opening 226b. In some embodiments, the upper surface 227 can include flanges, collars, or ridges to further guide water droplets away from a position, such that they can re-enter the panel 220 via the drain opening 226.

After exiting the panels 220 via the drain openings 226, water can flow to gutters (not shown). In some embodiments, the water can flow to the gutters via drainage channels (not shown). In some embodiments, the water can flow to the gutters via a series of flow channels. In some embodiments, the gutters can be fluidically coupled to a reservoir or water tank (not shown). In some embodiments, the reservoir can be integrated into the housing 215. In some embodiments, the reservoir can be molded into the housing 215. For example, a back panel of the housing can be molded to have a J-shape, such that vertical portion of the pack panel directs water down towards the curved reservoir portion integrally formed with the back panel. Such a construction can reduce leaks, simplify assembly, and/or reduce manufacturing costs. In some embodiments, water can be recirculated from the reservoir back into the panels 220. The water that exits the panels 220 can include dirt or sediments that can clog the various tubes of the plant support system 200. Accordingly, the plant support system 200 can include one or more filters 249 to filter and clean water that passes from the gutters to the reservoir. In some embodiments, the filters 249 can include indicators (e.g., indicator lights) to show the general health of the filters 249 and inform when they should be replaced. In some embodiments, the filters 249 can include indicators disposed therein. In some embodiments, the plant support system 200 can include instrumentation to monitor the general health of the filters 249 disposed in a separate location from the filters 249 (e.g., in the gutters and/or the reservoir, measuring water purity). In some embodiments, the plant support system 200 can include additional filters (not shown) that filter water passing form the reservoir to the pumps 242. The filters included in the plant support system 200 can implement various degrees of filtration.

In some embodiments, the pumps 242 and/or the moisture sensors can be in communication with the mobile hotspot device, such that the pumps 242 and/or the moisture sensors can be remotely accessed and operated. The pumps 242 can be electrically connected to a power source via a power supply (e.g., a power strip). In some embodiments, the power supply can be in communication with the mobile hotspot device, such that the power supply can be remotely accessed and operated. In some embodiments, the moisture sensors can use the mobile hotspot device to send data to a user interface (e.g., an online dashboard). The user can view the user interface to monitor the moisture level on each row of the panels 220 or in each of the panels 220. Based on the moisture level readings, the user can make changes to the settings of the pumps 242 to distribute water as desired.

FIG. 3D shows view of a cross section of one of the panels 220, showing an interior of the panel 220. As shown in FIG. 3D, the panel 220 includes seeding holes 222 and air gap strips 223. The air gap strips 223 can improve aeration of plants housed in the panel 220.

The panels 220 can be constructed of rotomolded plastic, which can produce light weight parts sophisticated geometries at low costs. The housing 215 can be the principle structural element of the plant support system, and may be constructed of, for example, aluminum. It should be understood, however, that the housing 215 and/or the panels 220 can be constructed of any suitable material, including, for example, a polymer, a metal, an injection molded or 3D printed plastic, etc. Preferably, the individual panels 220 can be removably coupled to the housing 215, such that they can be replaced individually in the event of a defect, plant death, or maintenance issue. For example, the housing 215 and/or the panels 220 can include a clip, a slot and groove arrangement, or any other suitable removable/reversable coupling configuration. In some embodiments, the panels 220 can be coupled to and removed from the housing 215 without the use of tools. In addition or alternatively, the panels 220 can be coupled together and/or coupled to the housing 215 via an adhesive, welding, brazing, couplings that snap together, or any combination thereof. In some instances, the panels 220 can connect to each other vertically. In some instances, the panels 220 can connect to each other horizontally. In some instances, the panels 220 can connect to each other both vertically and horizontally. In some instances, the panels 220 can include custom framing elements or designs (e.g., customizable skins). In some instances, the panels 220 can be stackable upon one another, such that they can be shipped in space-efficient containers.

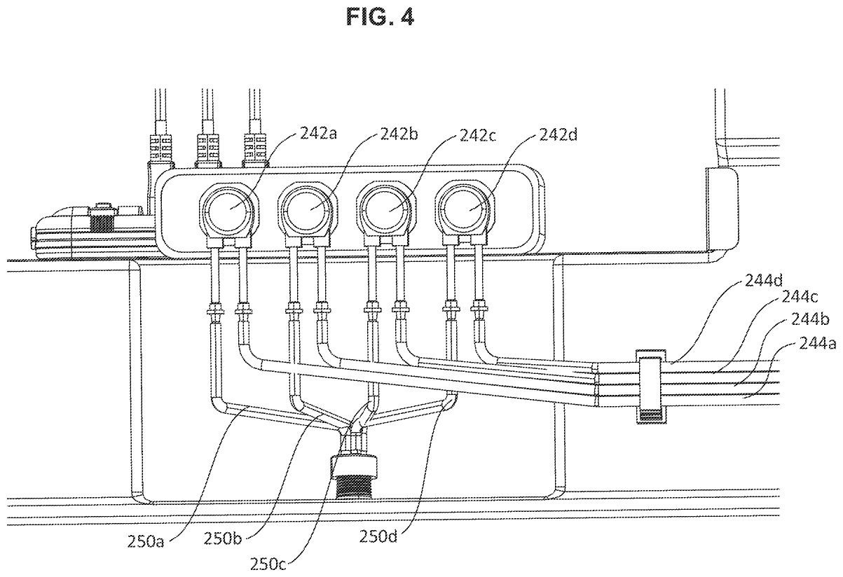

FIG. 4 shows various components of the water delivery system 240, according to an embodiment. More specifically, FIG. 4 shows pumps 242a, 242b, 242c, 242d (collectively referred to as pumps 242) fluidically coupled to the reservoir via feeder lines 250a, 250b, 250c, 250d (collectively referred to as feeder lines 250). The pumps 242 are also fluidically coupled to riser lines 244a, 244b, 244c, 244d (collectively referred to as riser lines 244). The pumps can be peristaltic pumps, centrifugal pumps, piston pumps, rotary gear pumps, metering pumps, magnetically driven pumps, or any combination thereof.

The feeder lines 250 can fluidically couple the pumps 242 to a reservoir. In some embodiments, the feeder lines 250 can feed from different reservoirs. For example, the feeder line 250a can feed from a first reservoir and the feeder line 250b can feed from a second reservoir. This can be beneficial if each row of the panels 220 includes plants with differing nutrient needs. Water with a first nutrient recipe can be contained in the first reservoir, while water with a second nutrient recipe can be contained in the second reservoir.

In some instances, each of the pumps 242 can be configured deliver the same or substantially the same amount of water to their respective rows of panels 220. In other instances, the pumps 242 can deliver different amounts of (metered) water to their respective rows of panels 220. For example, the pump 242a can deliver a first volume of water to a first row of the panels 220 while the pump 242b delivers a second volume of water to a second row of the panels 220, the second volume of water different from the first volume of water. In some instances, each of the pumps 242 can be calibrated to deliver water to a particular height. For example, the pump 242a can be calibrated to deliver metered (e.g., known) quantities of water against a first fluid head, and the pump 242b can be calibrated to deliver metered (e.g., known) quantities of water against a second fluid head, the second fluid head greater than the first fluid head. Similarly stated, pump 242a delivers water to the first row of panels 220 and the pump 242b delivers water to the second row of panels higher than the first row of panels 220. In some instances, the pumps 242 can deliver more water to higher levels of the panels 220 than to lower levels of the panels 220. For example, the pump 242d can deliver more water to a fourth row of panels 220 than the pump 242a delivers to the first row of panels 220. This can be due to the higher rows of panels 220 being closer to a light source and/or a ceiling duct, such that more water is consumed from the higher rows of the panels 220. In other instances, pumps 242 can deliver more water to lower levels of the panels 220 than to higher levels of the panels. For example, in instances in which plants in lower panels are larger or otherwise consume more water.

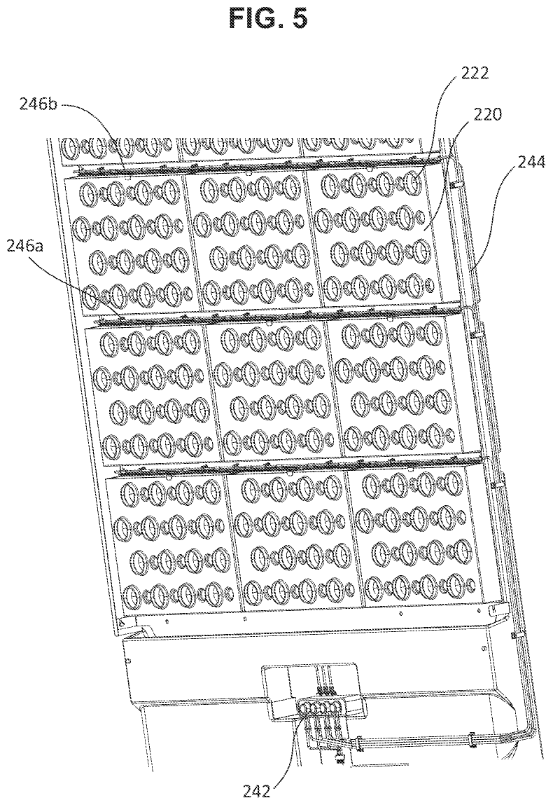

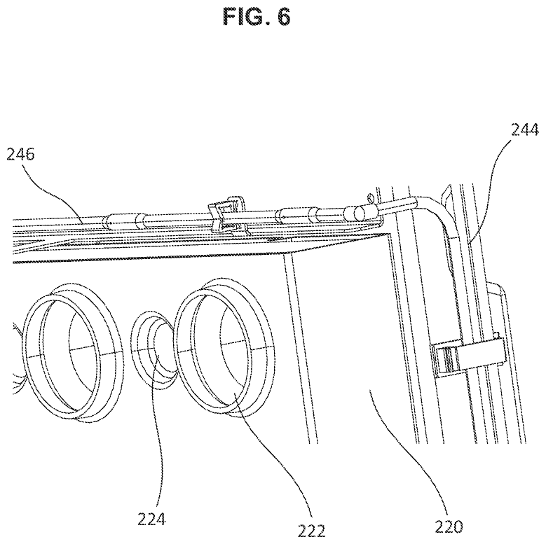

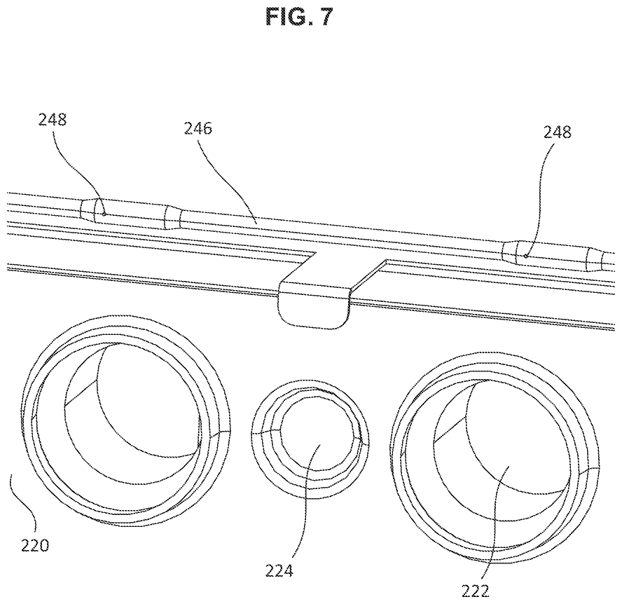

FIG. 5 and FIG. 6, and FIG. 7 show the riser lines 244 and the paths the riser lines 244 follow from the pumps 242 to the panels 220. As shown, a first riser line 244a is fluidically coupled to a first pump 242a and delivers water to a first row of the panels 220. Likewise, a second riser line 244b is fluidically coupled to a second pump 242b and delivers water to a second row of the panels 220.

As shown in FIG. 5, FIG. 6, and FIG. 7, each of the emitter lines 246 is configured to deliver water to a single row of the panels 220 and includes one or more drip holes 248 for delivery of water to the panels 220. Water can drip out of the emitter lines 246 to the panels via the drip holes 248. In some embodiments, the emitter lines 246 can include one drip hole 248 per panel 220. In some embodiments, the emitter lines 246 can include multiple drip holes 248 per panel 220. In some embodiments, instrumentation in the panels 220 (e.g., strain gauges) can aid in determining where a clog or flow impedance exists in an emitter line 246. For example, a sensor (e.g., a strain gauge) can be integrated into each of the columns of the panels 220. As an additional example, if the water is flowing from right to left through the emitter lines 246 and the third and fourth panels (when counting from the right side) on the third row of the panels 220 are not receiving water, there is likely a clog or stoppage between the second and third panels on the third row of the panels 220. In such a situation, the user can simply shut down the pump 242c that delivers water to the third row rather than shutting down all of the pumps 242. The user can then service the emitter line 246c that delivers water to the third row of the panels 220 without disturbing other portions of the plant support system 200.

As shown, the riser lines 244, the emitter lines 246, and the feeder lines 250 are visible on the outside of the plant carrier system 210. In some embodiments, the riser lines 244, the emitter lines 246, and/or the feeder lines 250 can be routed internally (i.e., inside the panels 220), such that they are not visible to an outside observer. This can reduce or eliminate risk of the riser lines 244, the emitter lines 246, and/or the feeder lines 250 becoming pulled or tangled.

In some embodiments, the drip holes 248 can have a diameter of at least 50 μm, at least 100 μm, at least 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, at least 800 μm, at least 850 μm, at least 900 μm, at least 950 μm, at least 1 mm, at least 1.5 mm, at least 2 mm, at least 2.5 mm, at least 3 mm, at least 3.5 mm, at least 4 mm, or at least 4.5 mm. In some embodiments, the drip holes 248 can have a diameter of no more than 5 mm, no more than 4.5 mm, no more than 4 mm, no more than 3.5 mm, no more than 3 mm, no more than 2.5 mm, no more than 2 mm, no more than 1.5 mm, no more than 1 mm, no more than 900 μm, no more than 850 μm, no more than 800 μm, no more than 750 μm, no more than 700 μm, no more than 650 μm, no more than 600 μm, no more than 550 μm, no more than 500 μm, no more than 450 μm, no more than 400 μm, no more than 350 μm, no more than 300 μm, no more than 250 μm, no more than 200 μm, no more than 150 μm, or no more than 100 μm.

Combinations of the above-referenced diameters of the drip holes 248 are also possible (e.g., at least 50 μm and no more than 5 mm), inclusive of all values and ranges therebetween. In some embodiments, the drip holes 248 can have diameters of 50 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 1 mm, 1.5 mm, 2 mm, 2.5 mm, 3 mm, 3.5 mm, 4 mm, 4.5 mm, or 5 mm.

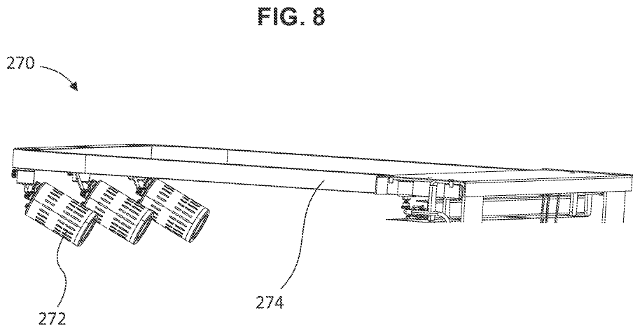

As shown in FIG. 8, the illumination system 270 includes multiple light sources 272. The light sources 272 can be LEDs, light bulbs (incandescent or fluorescent), or any other suitable light source. The illumination system 270 can also include a support beam 274. The support beam 274 physically supports the light sources 272 and holds the light sources 272 in such a position that they can properly illuminate the panels 220. In some embodiments, electrical wiring can run through the support beam 274. In some embodiments, the support beam 274 can be foldable, such that the support beam 274 can fold down to be oriented parallel to the height of the housing 215.

As used herein, “plant” or “plant life” can include, but is not limited to organisms in the plantae kingdom. For example, when “plants” are described herein, it should be understood to include fungi grown as crops or for their aesthetic properties (e.g., mushrooms), lichens, algae, or other suitable organisms. Unless explicitly described otherwise, “plant(s)” and “plant life” generally refer to stationary organisms (or colonies of organisms) that at least partially grow in air and are fixed in a hydrated matrix (e.g., soil, rockwool, etc.).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, “water” can include, but is not limited to pure water. For example, when “water” is described herein, it should be understood to include water mixed with nutrients, plant growth supplements, or any other additives associated with plant support.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of panels, the set of panels can be considered as one panel with multiple portions, or the set of panels can be considered as multiple, distinct panels. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. For example, although plant carrier systems are generally described with panels arranged in rows and columns, it should be understood that any sort of organization panels is possible. For example, panels can be arranged in offset rows (e.g., a running bond), a hexagonal pattern, a pattern of concentric circles, a spiral pattern, etc. As another example, panels are generally shown and described as containing holes for the growth of multiple plants. It should be understood that panels can accommodate any number of plants, including one plant each. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An apparatus, comprising:
a housing configured to physically support a plurality of living plants, the housing configured to include a plurality of panels arranged in a vertical array of n rows and m columns, n and m being positive integers, each panel from the plurality of panels configured to contain a living plant from the plurality of living plants; and
a plurality of pumps, each pump from the plurality of pumps configured to deliver water to one of the rows in the housing.

2. The apparatus of claim 1, wherein:
a first pump from the plurality of pumps programmed deliver a first volume of water to a first row of the plurality of panels at a first pressure head corresponding to a height of the first row of the plurality of panels; and
a second pump from the plurality of pumps programmed to deliver a second volume of water to a second row of the plurality of panels at a second pressure head corresponding to a height of the second row of the plurality of panels.

3. The apparatus of claim 2, wherein:
the first volume of water is the same as the second volume of water; and
the first pressure head is different from the second pressure head.

4. The apparatus of claim 1, further comprising:
a plurality of riser lines; and
a plurality of emitter lines,
each riser line from the plurality of riser lines fluidically coupling a pump from the plurality of pumps to an emitter line from the plurality of emitter lines, and
each emitter line from the plurality of emitter lines fluidically coupled to a riser line and configured to deliver water to a single row of the plurality of panels.

5. The apparatus of claim 4, wherein each emitter line from the plurality of emitter lines includes a plurality of drip holes, each panel from the plurality of panels configured to be watered by at least one drip hole from the plurality of drip holes.

6. The apparatus of claim 1, further comprising:
a plurality of sensors, each of the m columns including a sensor from the plurality of sensors, each sensor from the plurality of sensors configured to detect when water is dripping from that column.

7. The apparatus of claim 6, wherein each sensor from the plurality of sensors includes a strain gauge.

8. The apparatus of claim 1, wherein each panel from the plurality of panels includes a drain opening configured to allow excess water to exit the panel.

9. The apparatus of claim 1, wherein each panel from the plurality of panels includes a drain opening configured to allow excess water to exit the panel, the apparatus further comprising:
a plurality of drainage channels, each drainage channel from the plurality of drainage channels configured to receive the excess water from each of the panels in a row.

10. The apparatus of claim 1, wherein each panel from the plurality of panels includes a drain opening configured to allow excess water to exit the panel, the apparatus further comprising:
a plurality of drainage channels, each drainage channel from the plurality of drainage channels configured to receive the excess water from each of the panels in a row;
a gutter, each drainage channel from the plurality of drainage channels feeding into the gutter; and
a water tank, the gutter draining into the water tank.

11. The apparatus of claim 10, wherein:
the n rows include a first row and a second row, the second row above the first row; and
each panel from the plurality of panels includes an outflow having an upper surface configured to direct water away from the drain opening of that panel such that water exiting the drain openings of panels in the second row cannot enter the drain openings in panels in the first row.

12. The apparatus of claim 10, wherein the plurality of pumps are configured to draw water from the water tank to recirculate water that drained from the plurality of panels.

13. The apparatus of claim 10, further comprising:
a filter configured to filter the water that drains into the water tank from the gutter.

14. The apparatus of claim 1, further comprising:
a light source configured to deliver light to a panel from the plurality of panels.

15. The apparatus of claim 1, wherein n is at least 2 and m is at least 2.

16. An apparatus, comprising:
a housing configured to physically support a plurality of living plants;
a plurality of panels removably coupled to the housing and arranged in a vertical array of a plurality of rows and a plurality of columns, each panel from the plurality of panels configured to contain a living plant from the plurality of living plants;
a pump configured to deliver water to at least one row from the plurality of rows; and
a valve fluidically coupled to the pump and configured to allow fluidic communication between the pump and a first row from the plurality of rows in a first configuration, the valve configured to allow fluidic communication between the pump and a second row from the plurality of rows in a second configuration.

17. The apparatus of claim 16, wherein:
the pump is fluidically isolated from the first row when the valve is in the second configuration and;
the pump is fluidically isolated from the second row when the valve is in the first configuration.

18. The apparatus of claim 16, further comprising:
a plurality of moisture sensors integrated into the housing such that each row of the plurality of rows of panels includes at least one moisture sensor.

19. The apparatus of claim 18, further comprising a mobile hotspot device, the mobile hotspot device in communication with the plurality of moisture sensors.

20. An apparatus, comprising:
a housing configured to physically support a plurality of living plants; and
a plurality of panels removably coupled to the housing, each panel from the plurality of panels configured to contain a living plant from the plurality of living plants, each panel of the plurality of panels including a drain opening configured to allow excess water to exit that panel, the plurality of panels including a first row of panels and a second row of panels, the second row of panels above the first row of panels,
each panel from the plurality of panels includes an outflow having an upper surface configured to direct water away from the drain opening of that panel such that water exiting the drain openings of panels in the second row cannot enter the drain openings of panels in the first row.

21. The apparatus of claim 20, further comprising:
a first drainage channel configured to receive water from the drain openings in a first column of panels; and
a second drainage channel configured to receive water from the drain openings in a second row of panels.

22. The apparatus of claim 21, further comprising:
a gutter configured to receive water from the first drainage channel and the second drainage channel; and
a tank configured to receive water from the gutter.

23. The apparatus of claim 21 wherein the outflows of each panel in the first column of panels is disposed within the first drainage channel.

24. The apparatus of claim 20, further comprising:
a plurality of pumps, each pump from the plurality of pumps configured to deliver water to one of the rows in the housing.

25. The apparatus of claim 20, further comprising:
a light source configured to deliver light to the plurality of panels, the light source including an arm mounted to a wall via a hinge.
